(19) United States
(12) Patent Application Publication
(10) Pub. No.: US 2021/0105188 A1
(43) Pub. Date: Apr. 8, 2021

(54) INFORMATION TRANSMISSION SYSTEM, INFORMATION TRANSMISSION METHOD, AND EDGE DEVICE

(71) Applicant: FUJITSU LIMITED, Kawasaki-shi (JP)

(72) Inventor: Nami Nagata, Kawasaki (JP)

(73) Assignee: FUJITSU LIMITED, Kawasaki-shi (JP)

(21) Appl. No.: 17/020,886

(22) Filed: Sep. 15, 2020

(30) Foreign Application Priority Data
Oct. 4, 2019 (JP) 2019-183371

(51) Int. Cl. H04L 12/24; G06K 9/62

(52) U.S. Cl. CPC H04L 41/14; G06K 9/6215; H04L 41/12

(57) ABSTRACT

An information transmission system includes a first edge device configured to detect a first feature corresponding to a first analysis target, and transmit the first feature, a second edge device configured to receive the first feature from the first edge device, detect a second feature corresponding to a second analysis target, determine whether the first feature and the second feature are similar, and transmit, when the first feature and the second feature are similar, first correspondence information indicating that the first analysis target and the second analysis target correspond to each other, and a server configured to receive the correspondence information from the second edge device.

### CROSS-REFERENCE TO RELATED APPLICATION

This application is based upon and claims the benefit of priority of the prior Japanese Patent Application No. 2019-183371, filed on Oct. 4, 2019, the entire contents of which are incorporated herein by reference.

### FIELD

The embodiment discussed herein is related to an information transmission system, an information transmission method, and an edge device.

### BACKGROUND

For example, a business entity that provides a service to users (hereafter also referred to simply as a business entity) constructs and operates an information processing system for providing the service to the users. For example, the business entity constructs an information processing system that analyzes the action pattern of an analysis target from video images captured in each of a plurality of edge devices (hereafter also referred to simply as edges).

In such an information processing system, each edge device identifies an analysis target that appears in a captured video image and extracts, in advance, information indicating the identified analysis target (hereafter, the information is also referred to as a feature). When accepting a condition from the user, a management apparatus, which is to analyze the action pattern of an analysis target, acquires features extracted from video images that meet the condition, from the edge devices, and analyzes the action pattern of the analysis target based on the acquired features.

Thereby, the information processing system may analyze the action pattern of an analysis target while reducing the amount of communication between each edge device and the management apparatus (for example, see Japanese Laid-open Patent Publication Nos. 2003-324720, 11-015981, 2016-071639, and 2016-127563).

### SUMMARY

According to an aspect of the embodiments, an information transmission system includes a first edge device configured to detect a first feature corresponding to a first analysis target, and transmit the first feature; a second edge device configured to receive the first feature from the first edge device, detect a second feature corresponding to a second analysis target, determines whether the first feature and the second feature are similar, and transmit, when the first feature and the second feature are similar, first correspondence information indicating that the first analysis target and the second analysis target correspond to each other; and a server configured to receive the correspondence information from the second edge device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a configuration of an information processing system;

FIG. 2 illustrates a hardware configuration of an edge device;

FIG. 3 illustrates a hardware configuration of a management apparatus;

FIG. 4 is a block diagram of functions of an edge device;

FIG. 5 is a block diagram of functions of a management apparatus;

FIG. 6 is a flowchart illustrating an outline of an information transmission process in an embodiment;

FIG. 7 is a flowchart illustrating an outline of an information transmission process in an embodiment;

FIG. 8 is a flowchart illustrating an outline of an information transmission process in an embodiment;

FIG. 9 illustrates a specific example in an embodiment;

FIG. 10 illustrates a specific example in an embodiment;

FIG. 11 illustrates a specific example in an embodiment;

FIG. 12 illustrates a specific example in an embodiment;

FIG. 13 is a flowchart illustrating an information transmission process in an embodiment in detail;

FIG. 14 is a flowchart illustrating an information transmission process in an embodiment in detail;

FIG. 15 is a flowchart illustrating an information transmission process in an embodiment in detail;

FIG. 16 is a flowchart illustrating an information transmission process in an embodiment in detail;

FIG. 17 is a flowchart illustrating an information transmission process in an embodiment in detail;

FIG. 18A depicts a specific example of first correspondence information;

FIG. 18B depicts a specific example of first correspondence information;

FIG. 19 depicts a specific example of second correspondence information;

FIG. 20 depicts a specific example of number-of-times information;

FIG. 21 depicts a specific example of number-of-times information;

FIG. 22 depicts a specific example of preference information;

FIG. 23 illustrates a specific example of an information transmission process;

FIG. 24 illustrates a specific example of an information transmission process;

FIG. 25 illustrates a specific example of an information transmission process;

FIG. 26 illustrates a specific example of an information transmission process; and

FIG. 27 illustrates a specific example of an information transmission process.

### DESCRIPTION OF EMBODIMENTS

In the rerated art, the feature that being extracted by each edge device is information that may identify a personal. Thus, the operator may not be able to transmit the feature acquired from each edge device to the management device and may not accumulate the feature in the management device from the viewpoint of security and the like. Therefore, the operator may not be able to associate the feature extracted by the different edge devices with the management device, and may not be able to analyze the operation pattern of the analysis target.

In one aspect, an object of the invention is to provide an information transmission system capable of associating feature extracted by different edge devices without transmitting the feature to the management device.

[Configuration of Information Processing System]

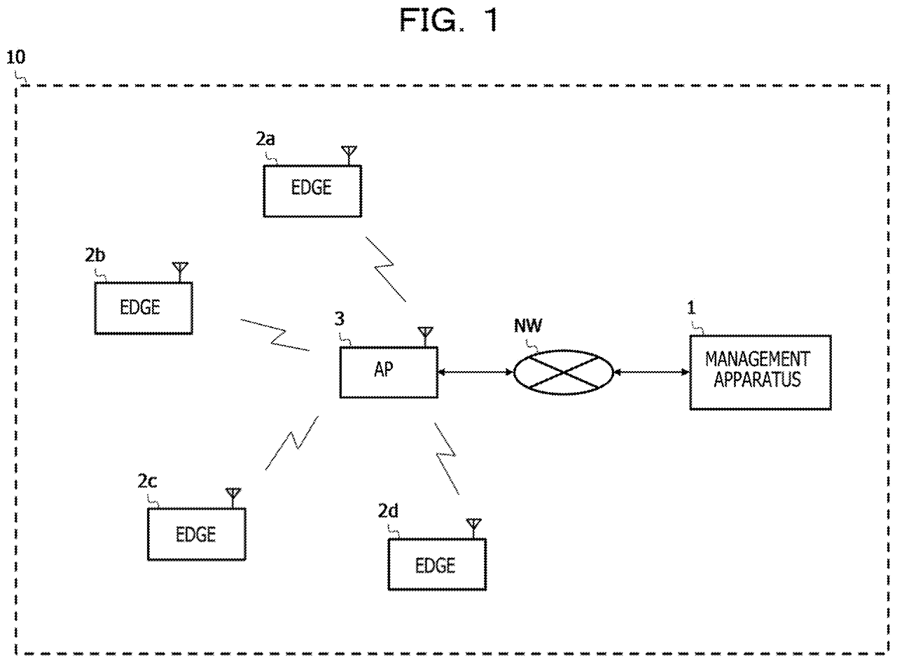

A configuration of an information processing system 10 will now be described. FIG. 1 illustrates a configuration of the information processing system 10.

As illustrated in FIG. 1, the information processing system 10 includes, for example, a management apparatus 1 (hereafter also referred to as a server device 1) deployed in a cloud, and edge devices 2a, 2b, 2c, and 2d (hereafter also collectively referred to simply as edge devices 2). Each edge device 2 is, for example, an information processing device including a camera (not illustrated) installed in a store or the like. As illustrated in FIG. 1, each edge device 2 establishes access to and from the management apparatus 1 by performing wired communication or wireless communication. For example, each edge device 2 establishes access to and from the management apparatus 1 by performing wired communication via a network NW and wireless communication via an access point 3. Although the case of including four edge devices 2 (edge devices 2a, 2b, 2c, and 2d) is described below, the information processing system 10 may include more than or less than four edge devices 2.

In the example illustrated in FIG. 1, the edge device 2a detects an analysis target (hereafter also referred to as a first analysis target) from a video image captured by a camera and extracts a feature (hereafter also referred to as a first feature) corresponding to the detected analysis target. For example, the edge device 2a detects a guest who visits a store, as the first analysis target, and extracts the first feature. The edge device 2a then transmits the extracted first feature to the edge device 2b.

Like the edge device 2a, the edge device 2b detects an analysis target (hereafter also referred to as a second analysis target) from a video image captured by a camera, and extracts a feature (hereafter also referred to as a second feature) corresponding to the detected analysis target.

The edge device 2b then determines whether the first feature received from the edge device 2a and the second feature extracted by the edge device 2b are similar. As a result, if it is determined that the first feature and the second feature are similar, the edge device 2b generates information indicating that the first analysis target detected by the edge device 2a and the second analysis target detected by the edge device 2b correspond to each other (hereafter the information is also referred to as first correspondence information or simply as correspondence information), and transmits the generated information to the management apparatus 1. For example, the edge device 2b generates first correspondence information indicating that the first analysis target and the second analysis target are the same targets, and transmits the first correspondence information to the management apparatus 1.

For example, each edge device 2 generates first correspondence information indicating a combination of features that are features extracted in different edge devices 2 and are related to the same analysis target. Each edge device 2 transmits, instead of a feature extracted in the edge device 2, the generated first correspondence information to the management apparatus 1.

Thereby, the management apparatus 1 may identify a combination of features that are extracted in different edge devices 2 and are related to the same analysis target, without acquiring a feature extracted in each of the edge devices 2. Therefore, without accumulating features in the management apparatus 1, a business entity may perform association of features acquired in different edge devices 2 and may analyze the action pattern of an analysis target.

[Hardware Configuration of Information Processing System]

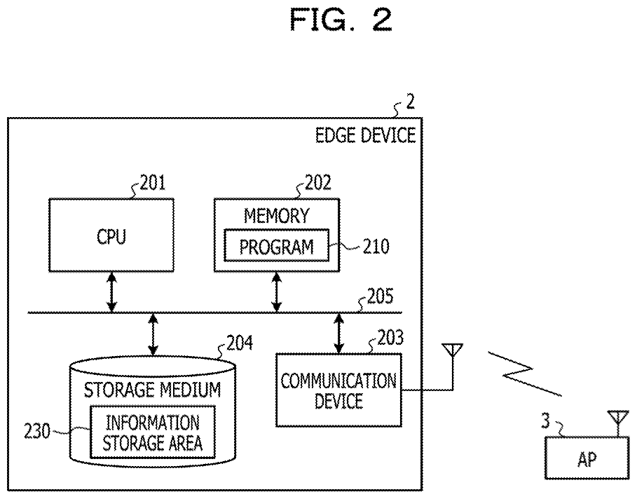

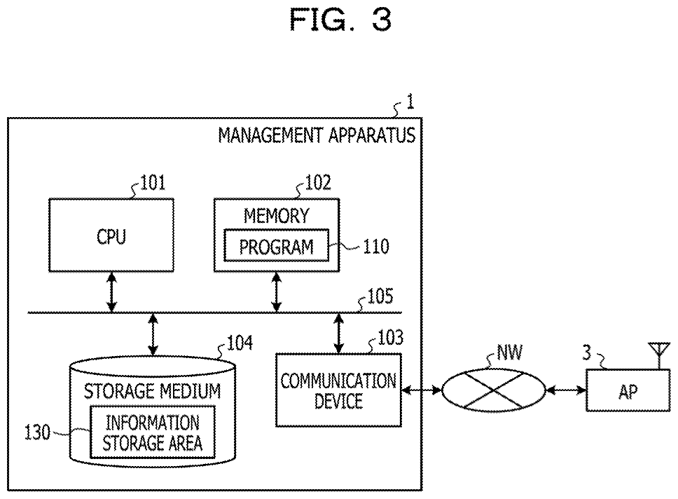

A hardware configuration of the information processing system 10 will now be described. FIG. 2 illustrates a hardware configuration of the edge device 2. FIG. 3 illustrates a hardware configuration of the management apparatus 1.

First, the hardware configuration of the edge device 2 will be described.

As illustrated in FIG. 2, the edge device 2 includes a central processing unit (CPU) 201 as a processor, a memory 202, a communication device 203, and a storage medium 204. These components are coupled to one another via a bus 205.

The storage medium 204 includes, for example, a program storage area (not illustrated) for storing a program 210 for performing a process for transmitting the first correspondence information from each edge device 2 to the management apparatus 1 (hereafter the process is also referred to as an information transmission process). The storage medium 204 also includes, for example, a storage unit 230 (hereafter also referred to as an information storage area 230) that stores information for use in performing the information transmission process. The storage medium 204 may be, for example, a hard disk drive (HDD) or a solid-state drive (SSD).

The CPU 201 executes the program 210 loaded from the storage medium 204 into the memory 202 to perform the information transmission process.

The communication device 203 wirelessly communicates with the access point 3, for example, by using wireless fidelity (Wi-Fi; registered trademark) or the like.

Next, the hardware configuration of the management apparatus 1 will be described.

As illustrated in FIG. 3, the management apparatus 1 includes a CPU 101 as a processor, a memory 102, a communication device 103, and a storage medium 104. These components are coupled to one another via a bus 105.

The storage medium 104 includes, for example, a program storage area (not illustrated) for storing a program 110 for performing the information transmission process. The storage medium 104 also includes, for example, a storage unit 130 (hereafter also referred to as an information storage area 130) that stores information for use in performing the information transmission process. The storage medium 104 may be, for example, an HDD or an SSD.

The CPU 101 executes the program 110 loaded from the storage medium 104 into the memory 102 to perform the information transmission process.

The communication device 103 communicates with the access point 3 in a wired manner via the network NW, for example.

[Functions of Information Processing System]

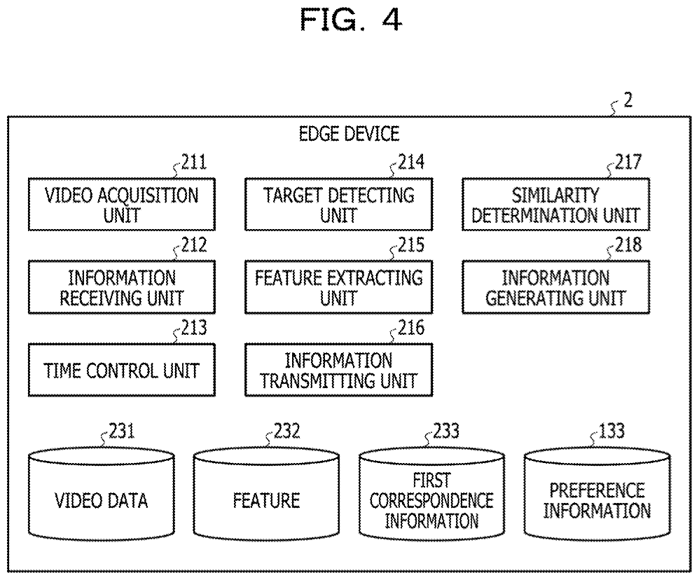

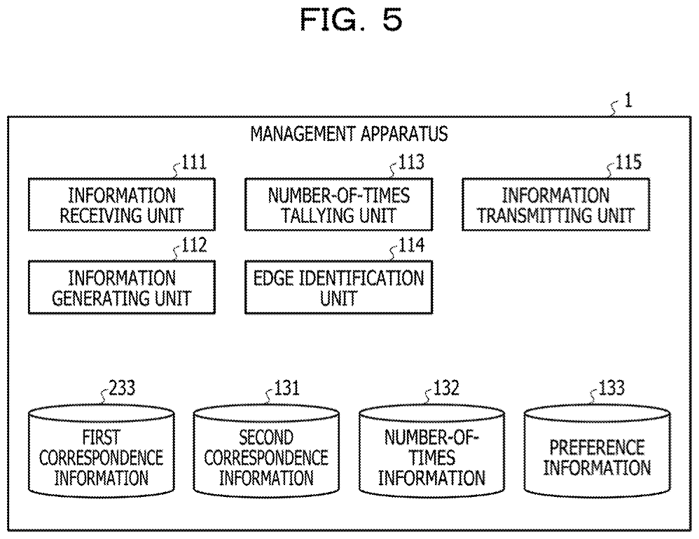

The functions of the information processing system 10 will now be described. FIG. 4 is a block diagram of functions of the edge device 2. FIG. 5 is a block diagram of functions of the management apparatus 1.

First, the block diagram of functions of the edge device 2 will be described.

As illustrated in FIG. 4, in the edge device 2, for example, hardware, such as the CPU 201 and the memory 202, and the program 210 organically cooperate with each other, such that the edge device 2 implements various functions including a video acquisition unit 211, an information receiving unit 212, a time control unit 213, a target detecting unit 214, and a feature extracting unit 215, an information transmitting unit 216, a similarity determination unit 217, and an information generating unit 218.

For example, as illustrated in FIG. 4, the edge device 2 stores video data 231, features 232, first correspondence information 233, and preference information 133.

The video acquisition unit 211 acquires the video data 231 captured by a camera (not illustrated) mounted on each edge device 2 and stores the acquired video data 231 in the information storage area 230.

The information receiving unit 212 receives a target time at which the information transmission process is to be performed, from an operation terminal (not illustrated) in which the business entity performs various operations.

The information receiving unit 212 acquires another feature 232 transmitted from another edge device 2. For example, the information receiving unit 212 acquires another feature 232 corresponding to another analysis target detected by another edge device 2.

The information receiving unit 212 receives the preference information 133 transmitted from the management apparatus 1 and stores the received preference information 133 in the information storage area 230. The preference information 133 is information indicating, to each edge device 2, another edge device 2 to which the edge device 2 is to preferentially transmit the feature 232.

The time control unit 213 identifies, among one or more pieces of video data 231 stored in the information storage area 230, one or more pieces of video data 231 corresponding to the target time received by the information receiving unit 212.

The target detecting unit 214 detects an analysis target determined in advance, by using the one or more pieces of video data 231 identified by the time control unit 213. For example, the target detecting unit 214 determines whether an analysis target appears in the one or more pieces of video data 231 identified by the time control unit 213.

The feature extracting unit 215 extracts the feature 232 corresponding to an analysis target detected by the target detecting unit 214. For example, the feature extracting unit 215 analyzes, among the one or more pieces of video data 231 identified by the time control unit 213, the video data 231 in which an analysis target detected by the target detecting unit 214 appears, thereby extracting the feature 232 corresponding to the analysis target.

The information transmitting unit 216 transmits the feature 232 extracted by the feature extracting unit 215, to another edge device 2.

The similarity determination unit 217 compares another feature 232 received by the information receiving unit 212 with the feature 232 extracted by the feature extracting unit 215. The similarity determination unit 217 determines whether the similarity relationship between the other feature 232 received by the information receiving unit 212 and the feature 232 extracted by the feature extracting unit 215 satisfies a predetermined condition. For example, the similarity determination unit 217 determines whether each of the other feature 232 received by the information receiving unit 212 and the feature 232 extracted by the feature extracting unit 215 is the feature 232 corresponding to the same analysis target (for example, the same person).

When the similarity determination unit 217 determines that the similarity relationship satisfies the predetermined condition, the information generating unit 218 generates the first correspondence information 233 indicating that the other analysis target detected by the other edge device 2 corresponds to the analysis target detected by the target detecting unit 214. In this case, the information transmitting unit 216 transmits the first correspondence information 233 generated by the information generating unit 218, to the management apparatus 1.

Next, a block diagram of functions of the management apparatus 1 will be described.

In the management apparatus 1, as illustrated in FIG. 5, for example, hardware, such as the CPU 101 and the memory 102, and the program 110 organically cooperate with each other, such that the management apparatus 1 implements various functions including an information receiving unit 111, an information generating unit 112, a number-of-times tallying unit 113, an edge identification unit 114, and an information transmitting unit 115.

For example, as illustrated in FIG. 5, the management apparatus 1 stores the first correspondence information 233, second correspondence information 131, number-of-times information 132, and the preference information 133 in the information storage area 130.

The information receiving unit 111 receives the respective pieces of first correspondence information 233 transmitted from the edge devices 2 and stores the received respective pieces of first correspondence information 233 in the information storage area 130.

From each of the respective pieces of first correspondence information 233 stored in the information storage area 130, the information generating unit 112 generates a piece of second correspondence information 131 indicating the correspondence relationship of each of the pieces of first correspondence information 233.

The number-of-times tallying unit 113 tallies the numbers of times that the first correspondence information 233 is transmitted from the edge devices 2. In this case, the information generating unit 112 generates the number-of-times information 132 indicating the numbers of times of transmission tallied by the number-of-times tallying unit 113.

The edge identification unit 114 references the number-of-times information 132 generated by the information generating unit 112 and identifies the respective edge device 2 to which each edge device 2 is to preferentially transmit the feature 232. In this case, the information generating unit 112 generates the preference information 133 indicating the edge device 2 identified by the edge identification unit 114.

The information transmitting unit 115 transmits the preference information 133 generated by the information generating unit 112, to each edge device 2.

[Outline of First Embodiment]

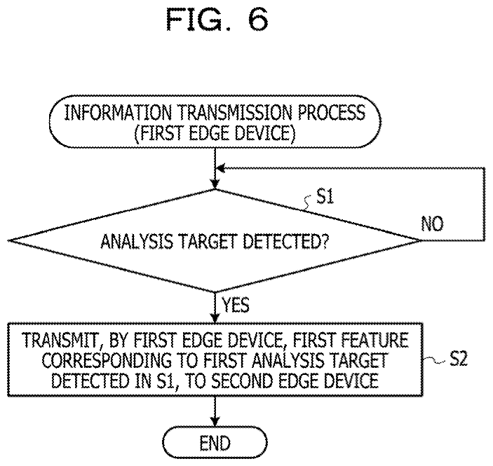

The outline of a first embodiment will now be described. FIGS. 6 to 8 are flowcharts illustrating the outline of the information transmission process in the first embodiment.

As illustrated in FIG. 6, a first edge device 2 waits until detecting any of analysis targets determined in advance (NO in S1). When detecting a first analysis target included in the analysis targets determined in advance (YES in S1), for example, the first edge device 2 transmits a first feature 232 corresponding to the first analysis target detected in S1, to a second edge device 2 (S2).

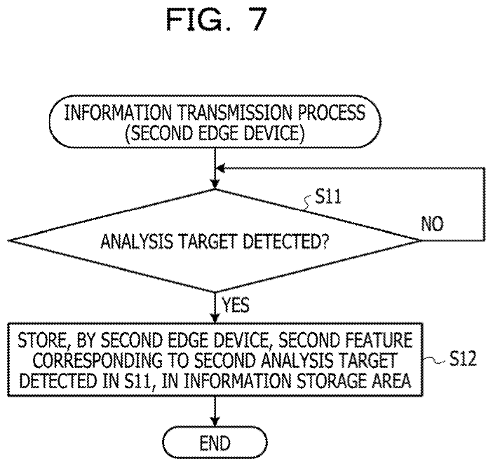

Meanwhile, as illustrated in FIG. 7, like the first edge device 2, the second edge device 2 waits until detecting any of the analysis targets determined in advance (NO in S11). When detecting a second analysis target included in the analysis targets determined in advance (YES in S11), for example, the second edge device 2 stores a second feature 232 corresponding to the second analysis target detected in S11, in the information storage area 230 (S12).

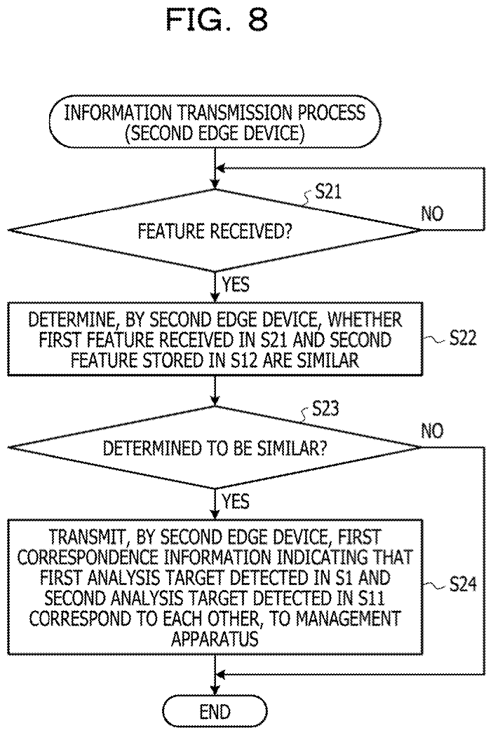

Thereafter, as illustrated in FIG. 8, the second edge device 2 waits until receiving the feature 232 from the other edge device (the first edge device 2) (NO in S21). For example, when receiving the first feature 232 transmitted by the first edge device 2 (YES in S21), the second edge device 2 determines whether the first feature 232 received in S21 and the second feature 232 stored in S12 are similar (S22).

As a result, when it is determined in S22 that the features 232 are similar (YES in S23), the second edge device 2 transmits the first correspondence information 233 indicating that the first analysis target detected by the first edge device 2 in S1 and the second analysis target detected by the second edge device 2 in S11 correspond to each other, to the management apparatus 1 (S24).

When it is determined in S22 that the features 232 are not similar (NO in S23), the second edge device 2 does not perform S24.

Thereby, the management apparatus 1 may identify a combination of the features 232 that are extracted in different edge devices 2 and are related to the same analysis target, without acquiring the feature 232 extracted in each of the edge devices 2. Therefore, without accumulating the features 232 in the management apparatus 1, the business entity may perform association of the features 232 acquired in different edge devices 2 and may analyze the action pattern of an analysis target.

[Specific Example of First Embodiment]

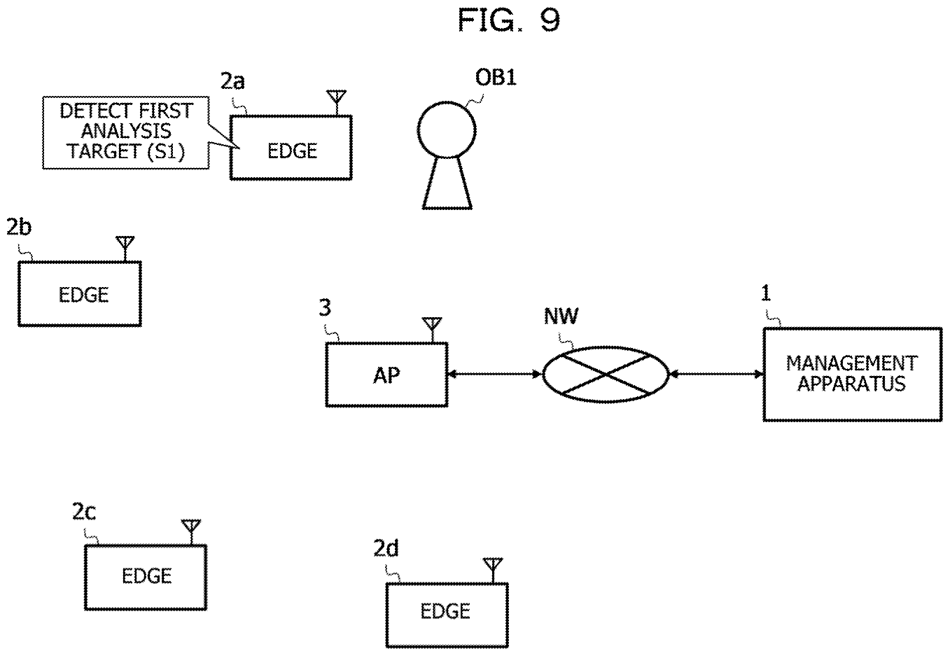

A specific example in the first embodiment will now be described. FIGS. 9 to 12 illustrate a specific example in the first embodiment.

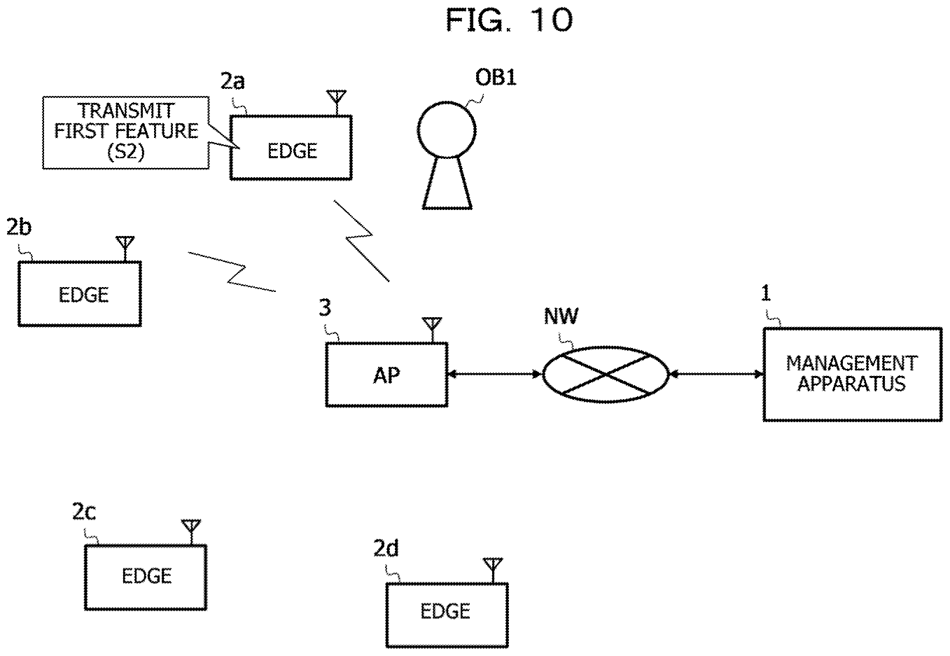

As illustrated in FIG. 9, for example, the edge device 2a detects the video data 231 in which an analysis target OB1 determined in advance appears (S1). As illustrated in FIG. 10, the edge device 2a then extracts the feature 232 of the analysis target OB1 from the detected video data 231 and transmits the extracted feature 232 to the edge device 2b (S2).

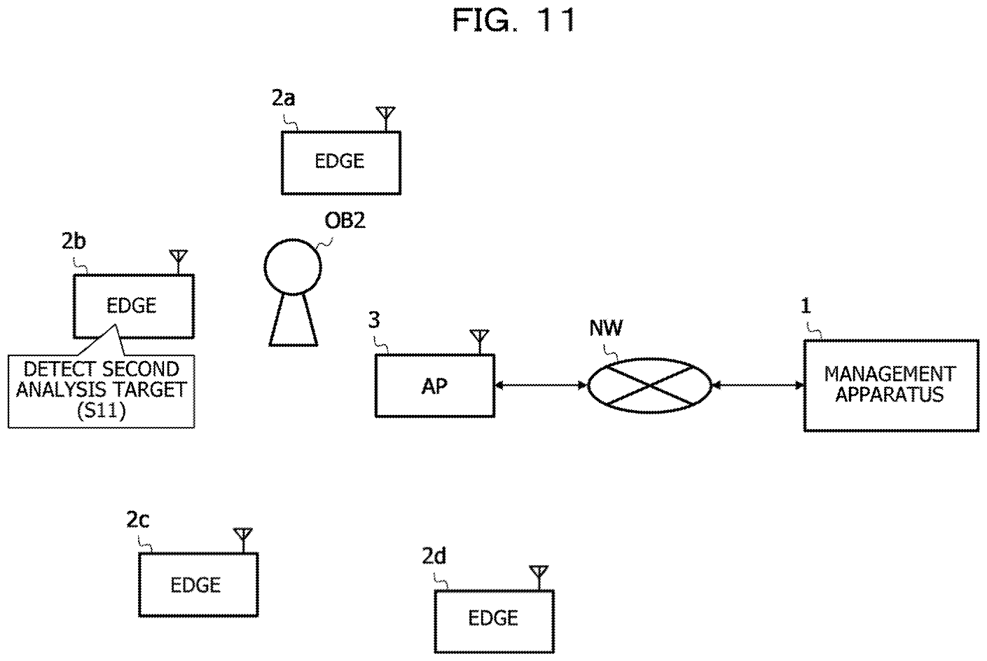

In contrast, as illustrated in FIG. 11, the edge device 2b receives the feature 232 of the analysis target OB1 transmitted from the edge device 2a, and, for example, detects the video data 231 in which an analysis target OB2 determined in advance appears (S11). The edge device 2b then extracts the feature 232 of the analysis target OB2 from the detected video data 231 and then stores the extracted feature 232 in the information storage area 130 (S12).

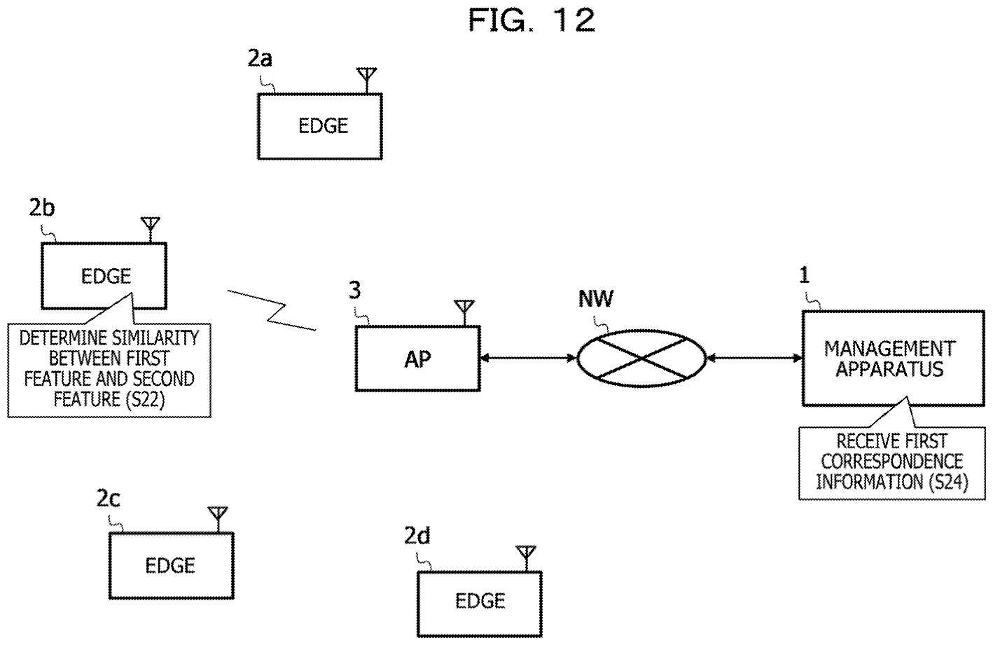

Thereafter, as illustrated in FIG. 12, the edge device 2b determines whether the analysis target OB1 detected by the edge device 2a and the analysis target OB2 detected by the edge device 2b are similar (S22). As a result, when it is determined that the analysis target OB1 and the analysis target OB2 are similar, the edge device 2b generates the first correspondence information 233 indicating that the analysis target OB1 and the analysis target OB2 are the same, and transmits the generated first correspondence information 233 to the management apparatus 1 (S24).

This enables the management apparatus 1 to determine whether the analysis target OB1 detected by the edge device 2a and the analysis target OB2 detected by the edge device 2b are the same analysis targets, by referencing the first correspondence information 233 transmitted from the edge device 2b. Therefore, without acquiring the feature 232 from each of the edge device 2a and the edge device 2b, the management apparatus 1 may analyze the action pattern of each analysis target.

[Details of First Embodiment]

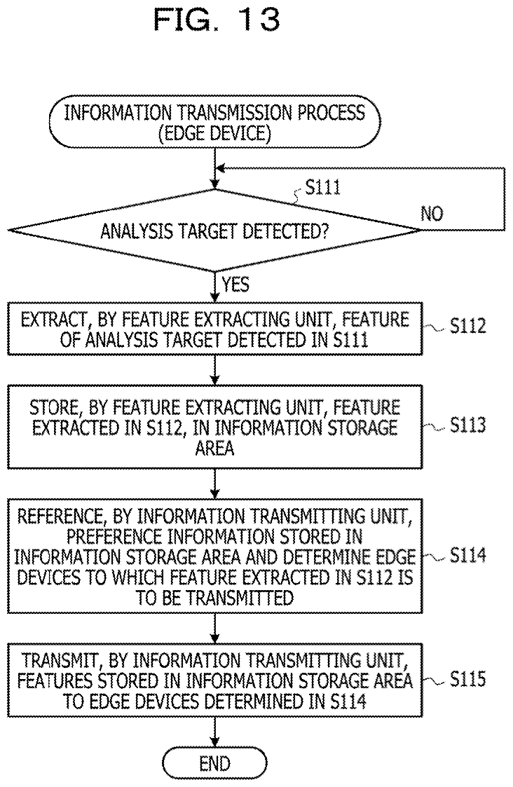

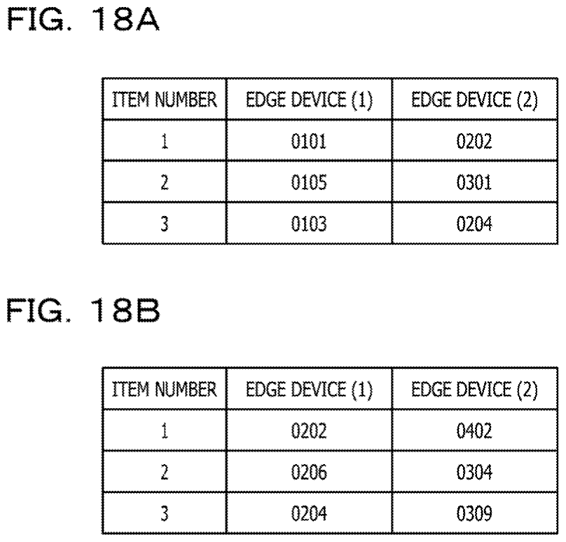

The first embodiment will now be described in detail. FIGS. 13 to 17 are flowcharts illustrating the information transmission process in the first embodiment in detail. FIGS. 18A to 27 depict the information transmission process in the first embodiment in detail.

[Information Transmission Process Performed in Each Edge Device]

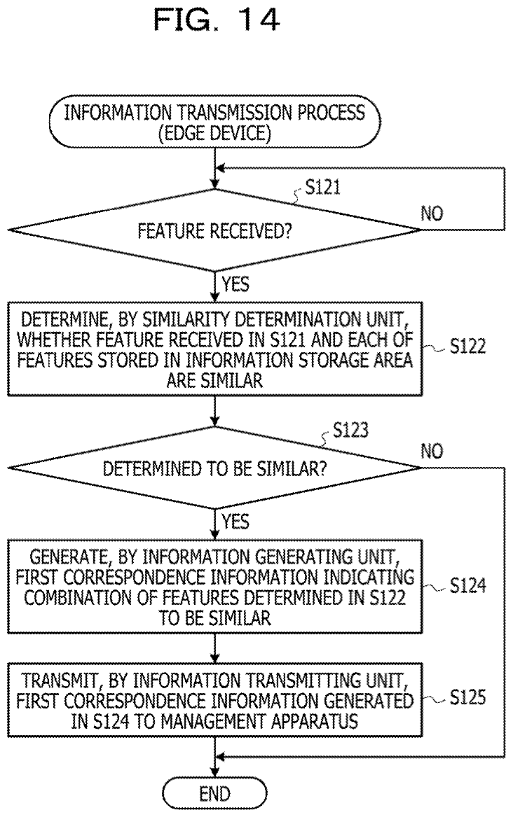

First, the information transmission process performed in each edge device 2 will be described. FIG. 13 and FIG. 14 are flowcharts illustrating the information transmission process performed in each edge device 2. The process performed in the edge device 2a will be described below. The process performed in each of the edge devices 2 other than the edge device 2a is the same as the process performed in the edge device 2a, and thus the description thereof is omitted.

As illustrated in FIG. 13, the target detecting unit 214 of the edge device 2a waits until detecting any of the analysis targets determined in advance (NO in S111). For example, at predetermined intervals, the target detecting unit 214 checks the video data 231 newly acquired by the video acquisition unit 211 (the video data 231 acquired within the most recent predetermined time period), thereby determining whether any of the analysis targets determined in advance appears in the video data 231.

When any analysis target determined in advance is detected (YES in S111), the feature extracting unit 215 of the edge device 2a extracts the feature 232 corresponding to the analysis target detected in S111, from the video data 231 stored in the information storage area 230 (S112).

Thereafter, the feature extracting unit 215 of the edge device 2a stores the feature 232 extracted in S112, in the information storage area 230.

Subsequently, the information transmitting unit 216 of the edge device 2a references the preference information 133 stored in the information storage area 230 and determines a certain number of edge devices 2 to which the feature 232 extracted in S112 is to be transmitted (S114).

The certain number as used herein is a number greater than or equal to one and, for example, may be determined in advance by the business entity. For example, the business entity may determine the certain number, for example, within a range where the processing burden on each edge device 2 and the traffic volume between the edge devices 2 do not exceed the thresholds. The details of S114 will be described later.

The information transmitting unit 216 transmits the features 232 (including the feature 232 extracted in S112) stored in the information storage area 230 to the certain number of edge devices 2 determined in S114 (S115).

For example, in this case, the information transmitting unit 216 transmits not only the feature 232 extracted in S112 but all the features 232 stored in the information storage area 230.

As illustrated in FIG. 14, the information receiving unit 212 of the edge device 2a waits until receiving the feature 232 from another edge device 2 (NO in S121).

When the feature 232 from another edge device 2 is received (YES in S121), the similarity determination unit 217 of the edge device 2a determines whether the first feature 232 received in S121 and each of the features 232 stored in the information storage area 130 are similar (S122).

For example, the similarity determination unit 217 determines whether the feature 232 received in S121 is similar to any of the features 232 previously detected by the target detecting unit 214 or any of the features 232 previously received by the information receiving unit 212.

As a result, when it is determined that the features 232 are similar (YES in S123), the information generating unit 218 of the edge device 2a generates the first correspondence information 233 indicating a combination of the features 232 determined in S122 to be similar (S124). Specific examples of the first correspondence information 233 will be described below.

[Specific Examples of First Correspondence Information]

FIG. 18A and FIG. 188 depict specific examples of the first correspondence information 233. FIG. 18A depicts a specific example of the first correspondence information 233 generated in the edge device 2a, and FIG. 18B depicts a specific example of the first correspondence information 233 generated in the edge device 2b.

The first correspondence information 233 depicted in each of FIG. 18A and FIG. 18B includes “item number” that identifies each piece of information included in the first correspondence information 233, and, as item elements, “edge device (1)” and “edge device (2)” in which the respective pieces of identification information of the features 232 determined in S122 to be similar are stored. A description will be given below assuming that four-digit numbers, each of which is made by combining a two-digit number for identifying each edge device 2 and a two-digit number for identifying the feature 232 detected in the edge device 2, are stored in “edge device (1)” and “edge device (2)”.

For example, in the piece of information with “item number” of “1” in the first correspondence information 233 depicted in FIG. 18A, “0101” indicating a first feature 232 detected in the edge device 2a is stored as “edge device (1)”, and “0202” indicating a second feature 232 detected in the edge device 2b is stored as “edge device (2)”.

In the piece of information with “item number” of “2” in the first correspondence information 233 depicted in FIG. 18A, “0105” indicating a fifth feature 232 detected in the edge device 2a is stored as “edge device (1)”, and “0301” indicating a first feature 232 detected in the edge device 2c is stored as “edge device (2)”.

In the piece of information with “item number” of “3” in the first correspondence information 233 depicted in FIG. 18A, “0103” indicating a third feature 232 detected in the edge device 2a is stored as “edge device (1)”, and “0204” indicating a fourth feature 232 detected in the edge device 2b is stored as “edge device (2)”.

In the piece of information with “item number” of “1” in the first correspondence information 233 depicted in FIG. 18B, “0202” indicating a second feature 232 detected in the edge device 2b is stored as “edge device (1)”, and “0402” indicating a second feature 232 detected in the edge device 2d is stored as “edge device (2)”.

In the piece of information with “item number” of “2” in the first correspondence information 233 depicted in FIG. 18B, “0206” indicating a sixth feature 232 detected in the edge device 2b is stored as “edge device (1)”, and “0304” indicating a fourth feature 232 detected in the edge device 2c is stored as “edge device (2)”.

In the piece of information with “item number” of “3” in the first correspondence information 233 depicted in FIG. 18B, “0204” indicating a fourth feature 232 detected in the edge device 2b is stored as “edge device (1)”, and “0309” indicating a ninth feature 232 detected in the edge device 2c is stored as “edge device (2)”.

With reference now to FIG. 14, the information transmitting unit 216 of the edge device 2a transmits the first correspondence information 233 generated in S124, to the management apparatus 1 (S125).

In S123, when it is determined that the features 232 are not similar (NO in S123), the edge device 2a does not perform S124 and S125.

[Information Transmission Process Performed in Management Apparatus]

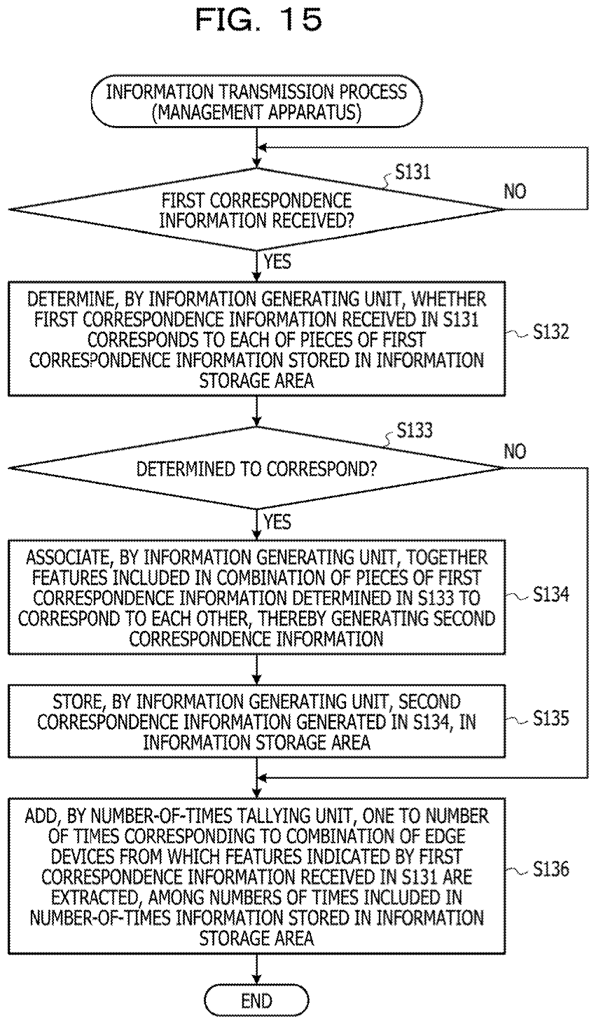

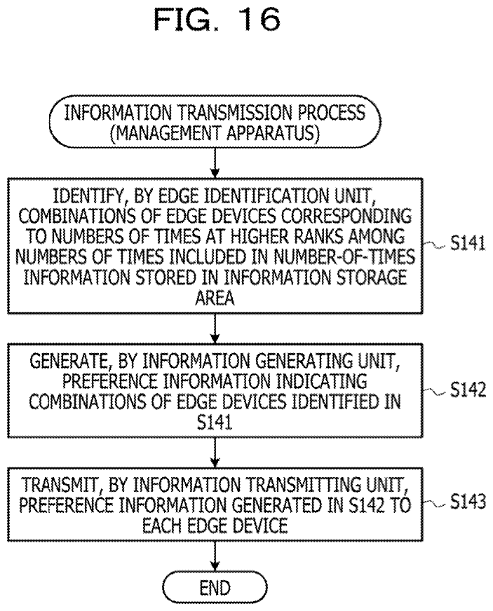

Next, the information transmission process performed in the management apparatus 1 will be described. FIG. 15 and FIG. 16 are flowcharts illustrating the information transmission process performed in the management apparatus 1.

As illustrated in FIG. 15, the information receiving unit 111 of the management apparatus 1 waits until receiving the first correspondence information 233 from any of the edge devices 2 (NO in S131).

When the first correspondence information 233 is received from any of the edge devices 2 (YES in S131), the information generating unit 112 determines whether the first correspondence information 233 received in S131 corresponds to each of the pieces of first correspondence information 233 stored in the information storage area 130 (S132).

As a result, when it is determined that the received first correspondence information 233 corresponds to any of the pieces of stored first correspondence information 233 (YES in S133), the information generating unit 112 of the management apparatus 1 associates together the features 232 included in a combination of the pieces of first correspondence information 233 that are determined in S133 to correspond to each other, thereby generating a piece of the second correspondence information 131 (S134). A specific example of the second correspondence information 131 will be described below.

[Specific Example of Second Correspondence Information]

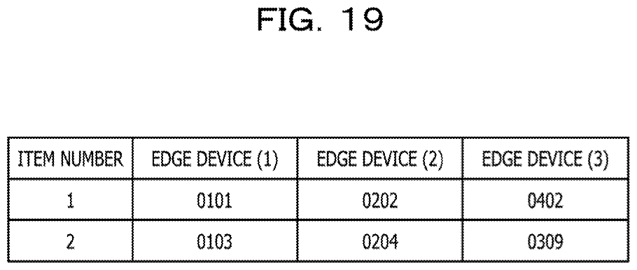

FIG. 19 depicts a specific example of the second correspondence information 131. It is assumed below that the first correspondence information 233 received in S131 is the first correspondence information 233 described with reference to FIG. 18A. It is also assumed below that the first correspondence information 233 stored in the information storage area 130 is the first correspondence information 233 described with reference to FIG. 18B.

The second correspondence information 131 depicted in FIG. 19 includes “item number” that identifies each piece of information included in the second correspondence information 131, and, as item elements, “edge device (1)”, “edge device (2)”, and “edge device (3)” in which the respective pieces of identification information of the features 232 included in the pieces of first correspondence information 233 determined in S132 to correspond to each other are stored.

For example, in the piece of information with “item number” of “1” of the first correspondence information 233 described with reference to FIG. 18A, “0101” is stored as “edge device (1)”, and “0202” is stored as “edge device (2)”. In the piece of information with “item number” of “1” of the first correspondence information 233 described with reference to FIG. 18B, “0202” is stored as “edge device (1)”, and “0402” is stored as “edge device (2)”.

For example, these pieces of information indicate that “0101” and “0202” are the features 232 generated from the same analysis target and that “0202” and “0402” are the features 232 generated from the same analysis target. Therefore, by referencing these pieces of information, the management apparatus 1 may determine that “0101” and “0402” are also the features 232 generated from the same analysis target.

Accordingly, as illustrated in FIG. 19, for example, the information generating unit 112 stores “0101”, “0202”, and “0402” in “edge device (1)”, “edge device (2)”, and “edge device (3)”, respectively, of the piece of information with the “item number” of “1”.

Similarly, in the piece of information with “item number” of “3” of the first correspondence information 233 described with reference to FIG. 18A, “0103” is stored as “edge device (1)” and “0204” is stored as “edge device (2)”. In the piece of information with “item number” of “3” of the first correspondence information 233 described with reference to FIG. 18B, “0204” is stored as “edge device (1)” and “0309” is stored as “edge device (2)”.

Therefore, as illustrated in FIG. 19, for example, the information generating unit 112 stores “0103”, “0204”, and “0309” in “edge device (1)”, “edge device (2)”, and “edge device (3)”, respectively, of the piece of information with the “item number” of “2”.

With reference now to FIG. 15, the information generating unit 112 of the management apparatus 1 stores the second correspondence information 131 generated in S134, in the information storage area 130 (S135).

The number-of-times tallying unit 113 of the management apparatus 1 adds one to the number of times corresponding to a combination of the edge devices 2 from which the features 232 indicated by the first correspondence information 233 received in S131 are extracted, among the numbers of times included in the number-of-times information 132 stored in the information storage area 130 (S136). Specific examples of the number-of-times information 132 will be described below.

[Specific Examples of Number-Of-Times Information]

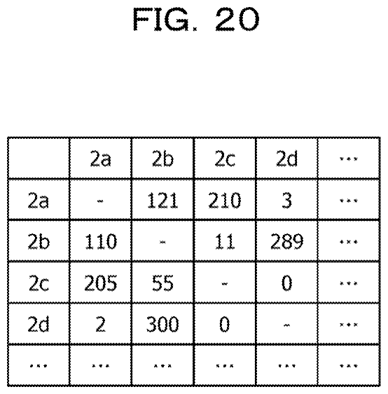

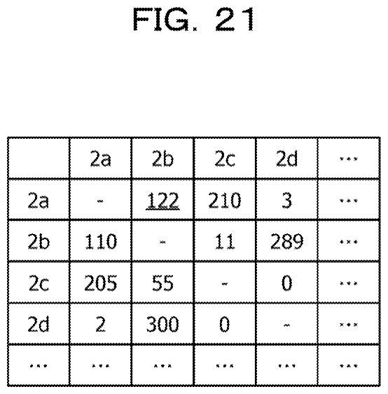

FIG. 20 and FIG. 21 depict specific examples of the number-of-times information 132.

In the number-of-times information 132 depicted in FIG. 20 and so on, the number of times that the first correspondence information 233 has been transmitted from each edge device 2 is stored in each box in each of columns with the headers “2a”, “2b”, “2c”, “2d”, and so on arranged in the horizontal direction. In the box where there is no information, the mark “-” is stored.

For example, “−”, “110 (times)”, “205 (times)”, “2 (times)”, and so on are stored in the boxes in the column with the header “2a” among the headers “2a”, “2b”, “2c”, “2d”, and so on arranged in the horizontal direction. For example, these boxes indicate that, for the first correspondence information 233 transmitted from the edge device 2a, the number of times of transmission of the first correspondence information 233 corresponding to a combination of the edge device 2a and the edge device 2b is “110 (times)”, the number of times of transmission of the first correspondence information 233 corresponding to a combination of the edge device 2a and the edge device 2c is “205 (times)”, and the number of times of transmission of the first correspondence information 233 corresponding to a combination of the edge device 2a and the edge device 2d is “2 (times)”.

For example, “121 (times)”, “-”, “55 (times)”, “300 (times)”, and so on are stored in the boxes in the column with the header “2b” among the headers “2a”, “2b”, “2c”, “2d”, and so on arranged in the horizontal direction. For example, these boxes indicate that, for the first correspondence information 233 transmitted from the edge device 2b, the number of times of transmission of the first correspondence information 233 corresponding to a combination of the edge device 2b and the edge device 2a is “121 (times)”, the number of times of transmission of the first correspondence information 233 corresponding to a combination of the edge device 2b and the edge device 2c is “55 (times)”, and the number of times of transmission of the first correspondence information 233 corresponding to a combination of the edge device 2b and the edge device 2d is “300 (times)”. Description of the other information included in FIG. 20 is omitted.

For example, after the state depicted in FIG. 20, when the first correspondence information 233 corresponding to the combination of the edge device 2b and the edge device 2a is received from the edge device 2b, as indicated in the box with the underlined number in FIG. 21, the information generating unit 112 updates the number stored in the box corresponding to “2b”, among “2a”, “2b”, “2c, “2d” and so on arranged in the horizontal direction, and “2a”, among “2a”, “2b”, “2c”, “2d”, and so on arranged in the vertical direction, to be “122 (times).

With reference now to FIG. 16, at a predetermined timing, the edge identification unit 114 of the management apparatus 1 identifies combinations of the edge devices 2 corresponding to the numbers of times at higher ranks among the numbers of times included in the number-of-times information 132 stored in the information storage area 130 (S141). The predetermined timing may be, for example, a timing determined in advance, such as once every hour. The combination of the edge devices 2 corresponding to the numbers of times at higher ranks may be, for example, combinations of the edge devices 2 corresponding to the top N ranked numbers of times or combinations of the edge devices 2 corresponding to the top P % of the numbers of times.

For example, in the case where, in the number-of-times information 132 described with reference to FIG. 21, “300 (times)” and “289 (times)” are determined to be included in the numbers of times at higher ranks, the edge identification unit 114 identifies combinations of the edge device 2b and the edge device 2d corresponding to these numbers of times.

The edge identification unit 114 may, for example, start execution of S141 when the total number of times that the first correspondence information 233 is transmitted from the edge devices 2 exceeds a threshold. For example, the edge identification unit 114 may generate the preference information 133 only when the number of times that the first correspondence information 233 is transmitted from the edge devices 2 exceeds the number of times determined in advance as the number of times for generating the preference information 133 having a high accuracy.

The information generating unit 112 of the management apparatus 1 generates the preference information 133 indicating combinations of the edge devices 2 identified in S141 (S142). A specific example of the preference information 133 will be described below.

[Specific Example of Preference Information]

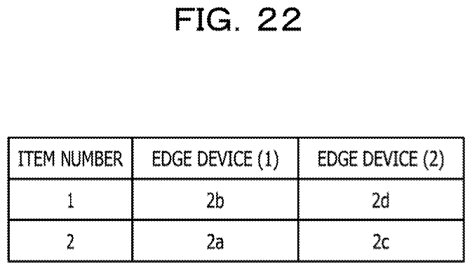

FIG. 22 depicts a specific example of the preference information 133.

The preference information 133 depicted in FIG. 22 includes “item number” that identifies each piece of information included in the preference information 133 and, as item elements, “edge device (1)” and “edge device (2)” in which the edge devices 2 included in a combination identified in S141 are stored respectively.

For example, in S141, when a combination of the edge device 2b and the edge device 2d is identified, the information generating unit 112 stores “2b” and “2d” in “edge device (1)” and “edge device (2)”, respectively, of the piece of information with the “item number” of “1”. Description of the other piece of information included in FIG. 22 is omitted.

In S141, the edge identification unit 114 may calculate, for each edge device 2, the transmission ratio of transmission from the edge device 2 to the other edge devices 2, in accordance with the numbers of times included in the number-of-times information 132 stored in the information storage area 130. In S142, the information generating unit 112 may generate, as the preference information 133, information indicating the transmission ratio calculated by the edge identification unit 114.

With reference now to FIG. 16, the information transmitting unit 115 transmits the preference information 133 generated in S142 to each edge device 2 (S143). The details of S114 described with reference to FIG. 13 (the processing performed in each edge device 2) will be described below.

[Details of S114]

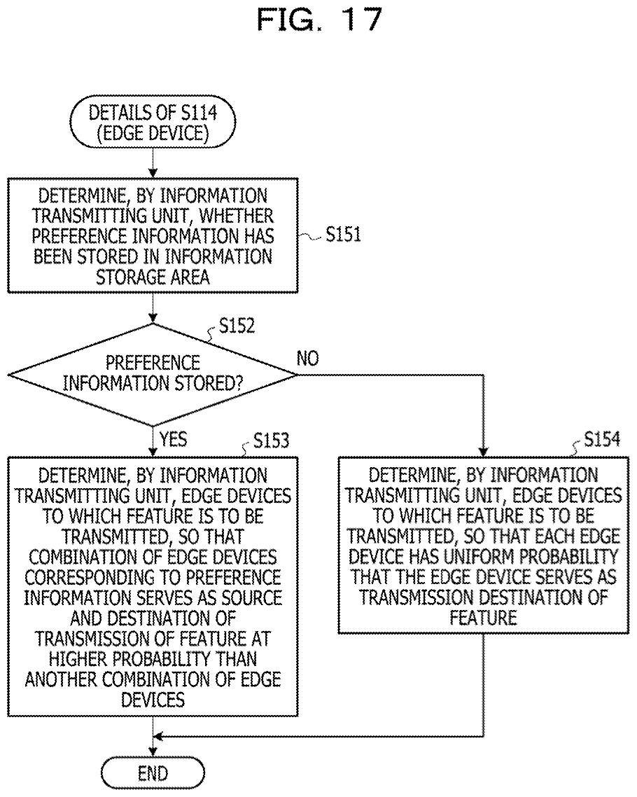

FIG. 17 is a flowchart illustrating S114 in more detail.

As illustrated in FIG. 17, the information transmitting unit 216 determines whether the preference information 133 has been stored in the information storage area 230 (S151). For example, the information transmitting unit 116 determines whether the preference information 133 has been received from the management apparatus 1.

When it is determined that the preference information 133 is not stored in the information storage area 230 (NO in S152), the information transmitting unit 216 determines the edge devices 2 to which the feature 232 is to be transmitted, so that each edge device 2 has a uniform probability that the edge device 2 serves as a transmission destination of the feature 231 (S154). For example, in this case, the information transmitting unit 216 determines the edge devices 2 to which the feature 232 is to be transmitted, so as to equalize the number of times that each edge device 2 receives the feature 232 from another edge device 2.

When it is determined that the preference information 133 is stored in the information storage area 230 (YES in S152), the information transmitting unit 216 determines the edge devices 2 to which the feature 232 is to be transmitted, so that a combination of the edge devices 2 corresponding to the preference information 133 stored in the information storage area 230 serves as the source and destination of transmission of the feature 232 at a higher probability than another combination of the edge devices 2 (S153).

For example, the preference information 133 described with reference to FIG. 22 includes the piece of information in which “2b” and “2d” are stored in “edge device (1)” and “edge device (2)”, respectively, (the piece of information with “item number” of “1”) and the piece of information in which “2a” and “2c” are stored in “edge device (1)” and “edge device (2)”, respectively (the piece of information with “item number” of “2”).

Therefore, in S153, for example, the information transmitting unit 216 determines the edge devices 2 to which the feature 232 is to be transmitted, so that the probability that a combination of the source and destination of transmission of the feature 232 will be the edge device 2b and the edge device 2d and the probability that a combination of the source and destination of transmission of the feature 232 will be the edge device 2a and the edge device 2c are high.

Thereby, the management apparatus 1 may perform control so that, between the edge devices 2 in which the feature 232 corresponding to the same analysis target is highly likely to be detected, the feature 232 is transmitted and received at a higher frequency. Therefore, the management apparatus 1 may generate the second correspondence information 131 more efficiently and may perform association of analysis targets detected in different edge devices 2 more efficiently.

[Specific Examples of Information Transmission Process]

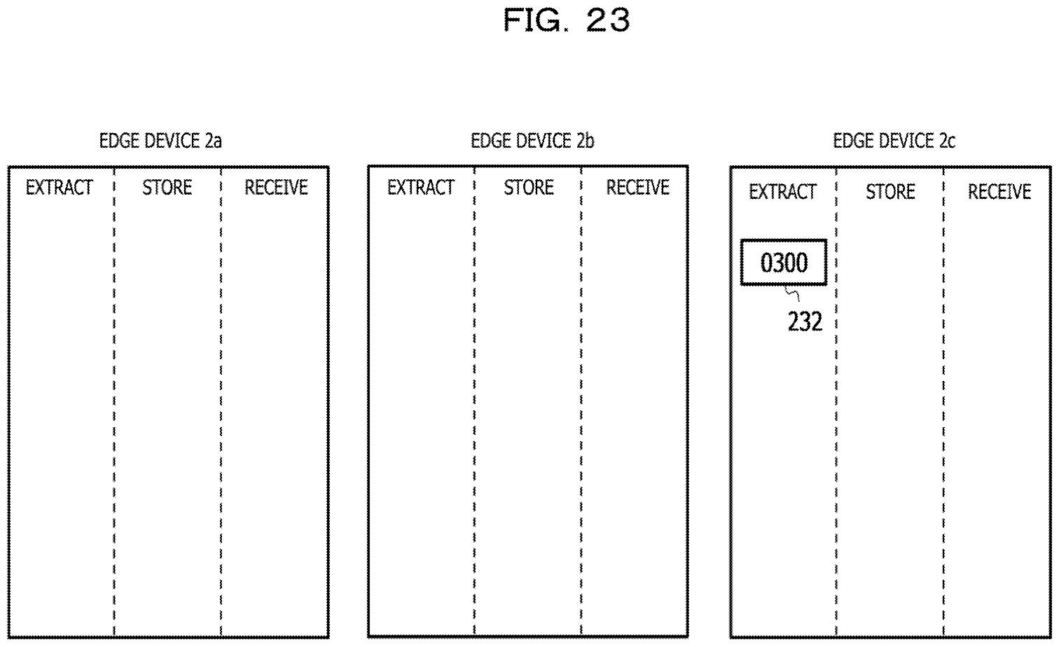

Specific examples of the information transmission process will now be described. FIG. 23 to FIG. 27 illustrate specific examples of the information transmission process. For example, FIGS. 23 to 27 illustrate a specific example of the case where t (time)=0, a specific example of the case where t=1, a specific example of the case where t=2, a specific example of the case wheret=3, and a specific example of the case where t=4, respectively. In the examples illustrated in FIGS. 23 to 27, a four-digit number surrounded by a box represents the identification information of each feature 232. For the sake of simplicity, description will be given below assuming that the information processing system 10 includes only the edge devices 2a, 2b, and 2c.

(Specific Examples of Edge Device 2a)

First, specific examples of the edge device 2a will be described.

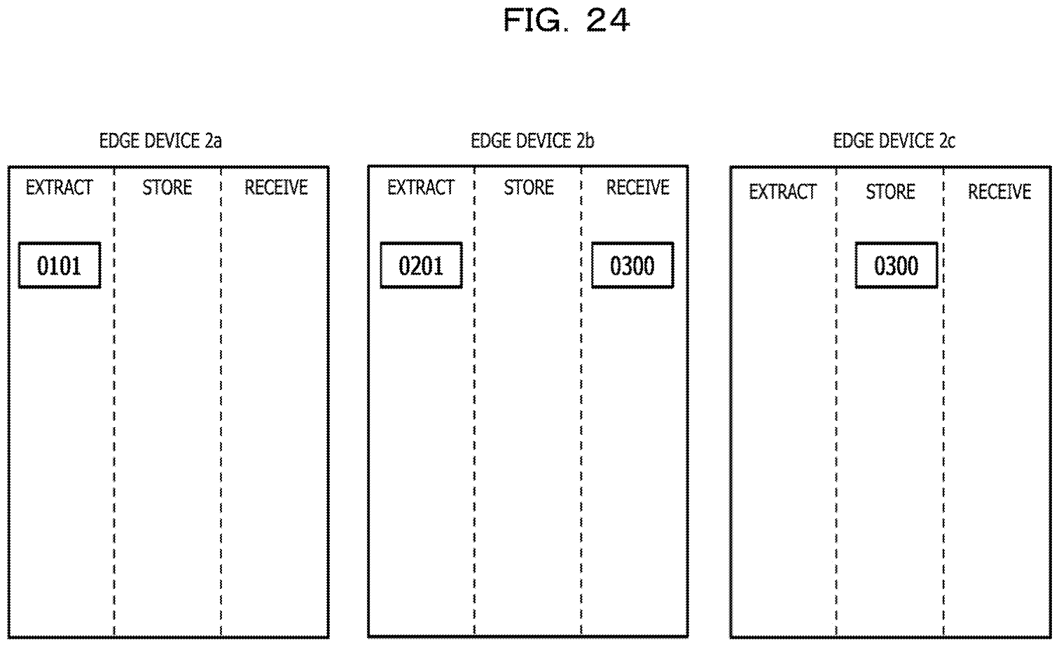

In the case (where t=1) illustrated in FIG. 24, the edge device 2a extracts “0101”.

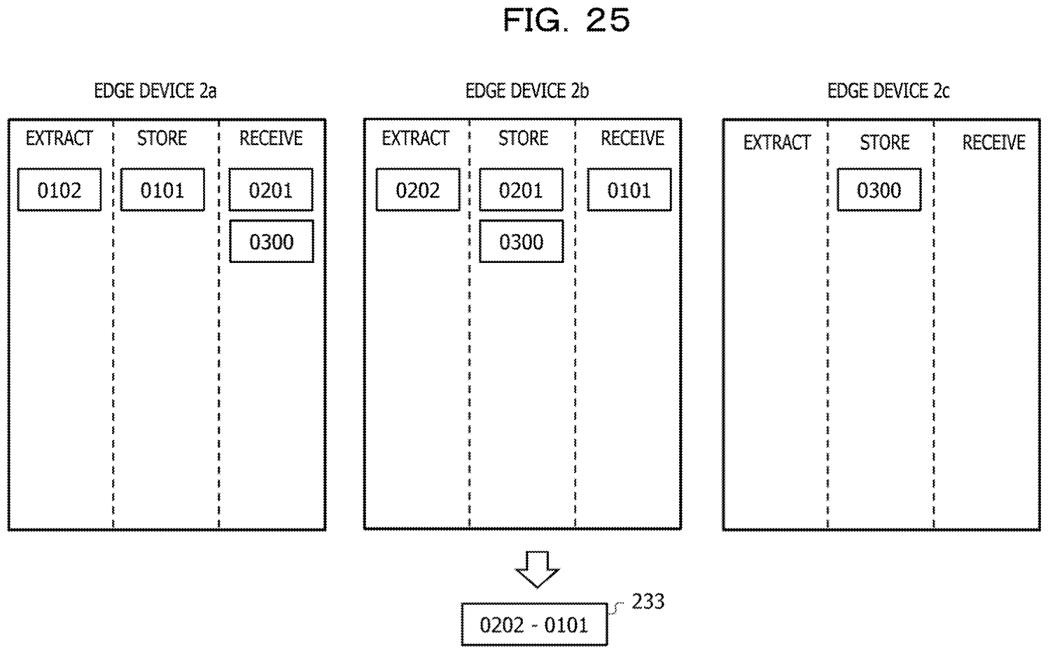

In the case (where t=2) illustrated in FIG. 25, the edge device 2a extracts “0102” and stores “0101”, which has already been extracted, in the information storage area 230. In this case, the edge device 2a receives “0201” and “0300” stored in the edge device 2b, from the edge device 2b.

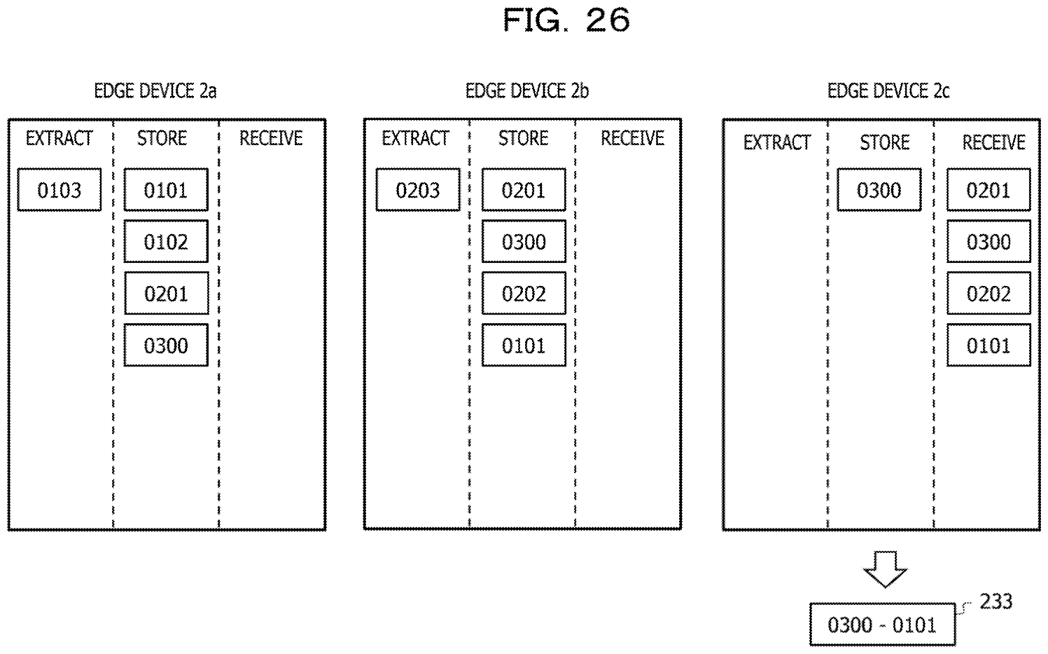

In the case (where t=3) illustrated in FIG. 26, the edge device 2a extracts “0103” and stores “0102”, which has already been extracted, in the information storage area 230. In this case, the edge device 2a stores “0201” and “0300”, which have already been received, in the information storage area 230.

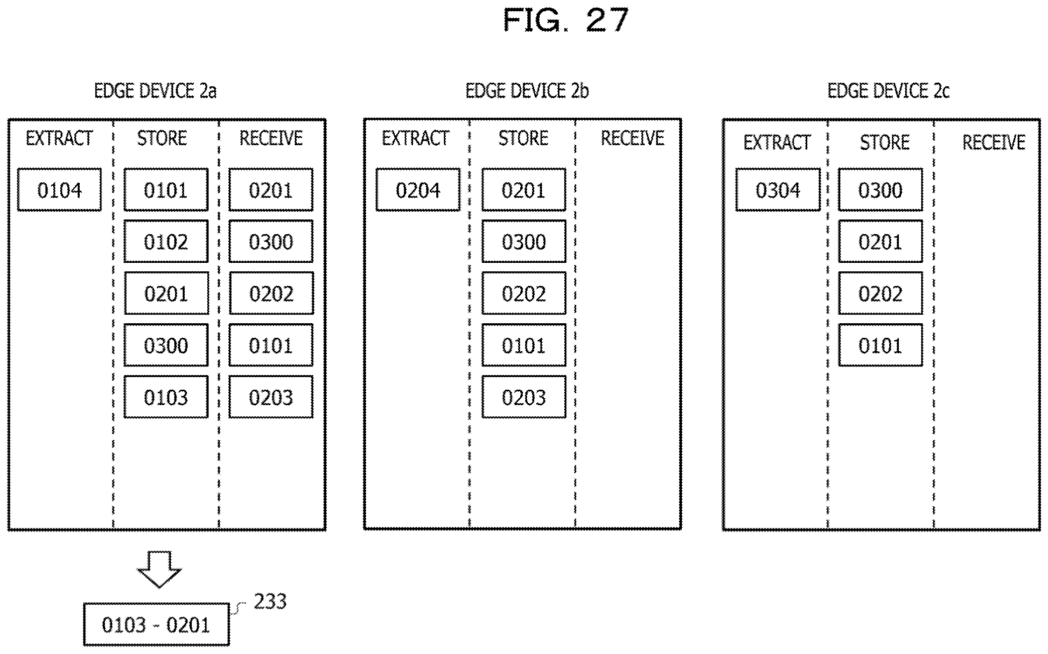

In the case (where t=4) illustrated in FIG. 27, the edge device 2a extracts “0104” and stores “0103”, which has already been extracted, in the information storage area 230. In this case, the edge device 2a receives “0201”, “0300”, “0202”, “0101”, and “0203” stored in the edge device 2b from the edge device 2b.

In the case (where t=4) illustrated in FIG. 27, the edge device 2a compares, in a round-robin way, each of “0104”, which is extracted, and “0101”, “0102”, “0201”, “0300”, and “0103”, which are stored in the information storage area 230, with “0201”, “0300”, “0202”, “0101”, and “0203” received from the edge device 2b. As a result, it is determined that “0103” stored in the information storage area 230 and “0201” received from the edge device 2b correspond to each other. The edge device 2a generates the first correspondence information 233 indicating that “0103” and “0201” correspond to each other, and transmits this first correspondence information 233 to the management apparatus 1.

(Specific Examples of Edge Device 2b)

Next, specific examples of the edge device 2b will be described.

In the case (where t=1) illustrated in FIG. 24, the edge device 2b extracts “0201”, and receives “0300” stored in the edge device 2c from the edge device 2c.

In the case (where t=2) illustrated in FIG. 25, the edge device 2b extracts “0202”, and stores “0201”, which has already been extracted, and “0300”, which has already been received, in the information storage area 230. In this case, the edge device 2b receives “0101” stored in the edge device 2a from the edge device 2a.

In the case (where t=2) illustrated in FIG. 25, the edge device 2b compares each of “0202”, which is extracted, and “0201” and “0300”, which are stored in the information storage area 230, with “0101” received from the edge device 2a. As a result, it is determined that “0202” extracted and “0101” received from the edge device 2c correspond to each other. The edge device 2b generates the first correspondence information 233 indicating that “0202” and “0101” correspond to each other, and transmits this first correspondence information 233 to the management apparatus 1.

In the case (where t=3) illustrated in FIG. 26, the edge device 2b extracts “0203”, and stores “0202”, which has already been extracted, and “0101”, which has already been received, in the information storage area 230.

In the case (where t=4) illustrated in FIG. 27, the edge device 2b extracts “0204” and stores “0203”, which has already been extracted, in the information storage area 230.

(Specific Examples of Edge Device 2c)

Next, specific examples of the edge device 2c will be described.

In the case (where t=0) illustrated in FIG. 23, the edge device 2c extracts “0300”.

In the case (where t=1) illustrated in FIG. 24, the edge device 2c stores “0300”, which has already been extracted, in the information storage area 230.

In the case (where t=3) illustrated in FIG. 26, the edge device 2c receives “0201”, “0300”, “0202”, and “0101” stored in the edge device 2b from the edge device 2b.

In the case (where t=3) illustrated in FIG. 26, the edge device 2c compares “0300” stored in the information storage area 230 with “0201”, “0300”, “0202”, and “0101” received from the edge device 2b. As a result, it is determined that “0300” stored in the information storage area 230 and “0101” received from the edge device 2b correspond to each other. The edge device 2c generates the first correspondence information 233 indicating that “0300” and “0101” correspond to each other, and transmits this first correspondence information 233 to the management apparatus 1.

In the case (where t=4) illustrated in FIG. 27, the edge device 2c extracts “0304”, and stores “0201”, “0202” and “0101” that have not yet been stored in the information storage area 230, among “0201”, “0300”, “0202”, and “0101” that have already been received, in the information storage area 230.

For example, in the specific examples described above, at predetermined intervals, each edge device 2 compares the extracted features 232 and the features 232 stored in the information storage area 230 with the features 232 received from other edge devices 2 in a round-robin way.

This enables each edge device 2 to identify a combination of the features 232 for which it may be determined that these features 232 have been extracted from the same analysis target.

This also enables the management apparatus 1 to generate the second correspondence information 131 based on the first correspondence information 233 transmitted from each edge device 2.

For example, in the specific examples described above, in the case (where t=2) illustrated in FIG. 25, the first correspondence information 233 indicating that “0202” and “0101” correspond to each other is transmitted to the management apparatus 1, and, in the case (where t=3) illustrated in FIG. 26, the first correspondence information 233 indicating that “0300” and “0101” correspond to each other is transmitted to the management apparatus 1. Therefore, in this case, the management apparatus 1 generates the second correspondence information 131 indicating that “0202”, “0101”, and “0300” correspond to one another.

In this way, the first edge device 2 in the present embodiment transmits the first feature 232 corresponding to the first analysis target detected by the first edge device 2, to the second edge device 2. The second edge device 2 determines whether the similarity relationship between the second feature 232 corresponding to the second analysis target detected by the second edge device 2 and the first feature 232 received from the first edge device 2 satisfies a condition.

When determining that the similarity relationship satisfies the predetermined condition, the second edge device 2 transmits the first correspondence information 233 indicating that the first analysis target and the second analysis target correspond to each other, to the management apparatus 1.

For example, each edge device 2 transmits only the first correspondence information 233 indicating a combination of features that are features 232 extracted in different edge devices 2 and are related to the same analysis target, to the management apparatus 1.

Thereby, the management apparatus 1 may identify a combination of the features 232 that are extracted in different edge devices 2 and are related to the same analysis target, without acquiring the feature 232 from each of the edge devices 2. Therefore, without accumulating the features 232 in the management apparatus 1, the business entity may perform association of the features 232 acquired in different edge devices 2. Accordingly, the business entity may analyze the action pattern of an analysis target.

Without depending on the position of each edge device 2, the management apparatus 1 may perform association of the features 232 acquired by different edge devices 2. Therefore, even when each edge device 2 is a moving device (for example, an onboard device), the management apparatus 1 may analyze the action pattern of an analysis target.

For example, in the case where there is an analysis target captured for a long time period by a camera of the same edge device 2 (for example, an analysis target that has not moved for a long time period), the feature 232 corresponding to the same analysis target is detected a plurality of successive times in each edge device 2. In such a case, in each edge device 2, for the sake of simplicity of the processing involved in comparison of the features 232, the features 232 detected a plurality of successive times are desirably provided with the same identification information.

Each edge device 2 may compare the newly extracted feature 232 with the feature 232 stored in the information storage area 230, as desired. When identifying a combination of the similar features 232 by this comparison, each edge device 2 may determine that there has been an analysis target captured for a long time period by a camera of the same edge device 2, and may provide each of the features 232 corresponding to the identified combination with the same identification information.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information transmission system comprising:
a first edge device configured to:
detect a first feature corresponding to a first analysis target, and
transmit the first feature;
a second edge device configured to:
receive the first feature from the first edge device,
detect a second feature corresponding to a second analysis target,
determine whether the first feature and the second feature are similar, and
transmit, when the first feature and the second feature are similar, first correspondence information indicating that the first analysis target and the second analysis target correspond to each other; and
a server configured to receive the correspondence information from the second edge device.

2. The information transmission system according to claim 1, further comprising:
a third edge device configured to:
receive the first feature from the first edge device,
detect a third feature corresponding to a third analysis target,
determine whether the first feature and the third feature are similar, and
transmit, when the first feature and the third feature are similar, to the server, second correspondence information indicating that the first analysis target and the third analysis target correspond to each other.

3. The information transmission system according to claim 2,
wherein the first edge device transmits to the third edge device the first feature after transmitting to the second edge device the first feature.

4. The information transmission system according to claim 2, wherein the server device is further configured to:
generate, from the first correspondence information and the second correspondence information, third correspondence information indicating that the first analysis target, the second analysis target, and the third analysis target correspond to one another, and
store the third correspondence information.

5. The information transmission system according to claim 1, wherein further comprising:
a fourth edge device configured to:
detect a fourth feature corresponding to a fourth analysis target, and
transmit the fourth feature to the second edge device, wherein,
the second edge device is further configured to:
store, when the first feature and the second feature are not similar, the first feature and the second feature,
determine whether each of the first feature and the second feature, and the fourth feature, are similar,
transmit, when determining that the first feature and the fourth feature are similar, to the server device, fourth correspondence information indicating that the first analysis target and the fourth analysis target correspond to each other, and
transmit, when determining that the second feature and the fourth feature are similar, to the server device, fifth correspondence information indicating that the second analysis target and the fourth analysis target correspond to each other.

6. The information transmission system according to claim 1,
wherein the first correspondence information is information indicating that the first analysis target and the second analysis target are same analysis targets.

7. The information transmission system according to claim 1, wherein the first edge device is further configured to:
receive, from the server device, edge information indicating, among a plurality of edge devices including the first edge device and the second edge device, a specific edge device in which a number of times of transmission of the correspondence information satisfies a condition,
identify, as the second edge device, the specific edge device corresponding to the edge information, and
transmit the first feature to the identified specific edge device.

8. The information transmission system according t claim 7,
wherein the specific edge device is, among the plurality of edge devices, an edge device in which the number of times of transmission is greater than the number of times of transmission of another edge device.

9. The information transmission system according to claim 1, wherein the first edge device is further configured to:
receive, from the server device, a ratio of a number of times of transmission of the correspondence information of each of the plurality of edge devices,
identify the second edge device from among the plurality of edge devices so as to cause a ratio of a probability that each of the plurality of edge devices is specified as the second edge device to correspond to the ratio received from the server device, and
transmit the first feature to the second edge device.

10. The information transmission system according to claim 1, wherein
the server transmits to the first edge device and the second edge device a detection condition of an analysis target,
the first edge device detects, as the first analysis target, an analysis target that satisfies the detection condition received from the server device, and
the second edge device detects, as the second analysis target, an analysis target that satisfies the detection condition received from the server device.

11. An information transmission method for transmitting, to a server device, information related to a plurality of analysis targets respectively detected in a plurality of edge devices including a first edge device and a second edge device, the information transmission method comprising:
transmitting, by the first edge device, a first feature corresponding to a first analysis target detected by the first edge device, to the second edge device,
determining, by the second edge device, whether the first feature and a second feature are similar, the second feature corresponding to a second analysis target detected by the second edge device, and
when determining that the first feature and the second feature are similar, transmitting, by the second edge device, correspondence information indicating that the first analysis target and the second analysis target correspond to each other, to the server device.

12. An edge device comprising:
a receiver configured to receive a first feature corresponding to a first analysis target detected by another edge device, from the another edge device,
a processor configured to detect second feature corresponding to a second analysis target and determine whether the first feature and a second feature are similar, and
a transmitter configured to, when it is determined that the first feature and the second feature are similar, transmit, to a server device, correspondence information indicating that the first analysis target and the second analysis target correspond to each other.
